(19) United States
(12) Patent Application Publication
(10) Pub. No.: US 2006/0143621 A1
(43) Pub. Date: Jun. 29, 2006

(54) Self-installing PCMCIA network card

(76) Inventor: Dan Ta Shan Wang, Irvine, CA (US)

Correspondence Address: Norman E. Carte;MacPHERSON KWOK CHEN & HEID LLP, Suite 226, 1762 Technology Drive, San Jose, CA, 95110, US

(21) Appl. No.: 11/025,430

(22) Filed: Dec. 29, 2004

(51) Int. Cl. G06F 9/445; G06F 13/00; G06F 9/44

(52) U.S. Cl. 719/327; 710/302; 717/174

(57) ABSTRACT

A method and system for facilitating the installation of device drivers for computer cards, such as PC Cards, is disclosed. The driver(s) are stored in a non-volatile memory of the card. Optionally, a driver installation program is stored in the memory or on firmware of the card. Storing the driver(s) in a non-volatile memory of the card assures that the driver(s) are available when needed for installation. The use of an automated driver installation program simplifies the installation procedure.

### TECHNICAL FIELD

The present invention relates generally to computer peripherals. The present invention relates more particularly to a self installing peripheral card, such as a PCMCIA wireless network card, for a computer.

### BACKGROUND

Computer cards for personal computers are well known. Cards for performing a wide variety of different functions using a wide variety of different interfaces or buses have been developed. For example, cards for providing a network connection (wired and wireless), mass storage, enhanced input/out capabilities, video capture, global positioning (GPS), security, and a number of other functions are available. Such cards may be available for buses including the Personal Computer Memory Card International Association (PCMCIA) bus (also known as the PC Card bus), the Peripheral Component Interconnect (PCI) bus, the VME Extensions for Instrumentation (VXI) bus, the Versatile Multibus Extension (VME) bus, and the Small Form-Factor ISA (PC-104) bus.

Frequently, the installation of such cards includes the loading of one or more drivers that are required by the operating system to facilitate communication between the card and the computer and/or to otherwise facilitate functioning of the card. Such drivers are commonly stored on a compact disc (CD), although they may also be stored on other media (such as floppy disks) or may be downloaded via the Internet. Thus, as a part of the installation procedure for the card, a driver must typically be installed on the computer.

Although such contemporary methods for providing peripheral device drivers have proven generally suitable for their intended purposes, they possess inherent deficiencies which detract from their overall effectiveness and desirability. For example, it is not uncommon for a user to lose the CD or other media upon which the driver is stored. This is particularly true when the card is being re-installed long after the original installation, since the driver CD is frequently misplaced after the card was initially installed. When a card is re-installed, such as when the card is moved to a different computer or when a hard drive of the computer is reformatted, then it may be difficult or impossible to locate the original driver.

Even when the driver can be readily located, the media upon which it is stored may have been compromised. For example, a CD may have been scratched or a floppy disk may have been exposed to a magnetic field, thus making the driver unusable.

In an attempt to alleviate the aforementioned problems regarding the availability of drivers, many card manufactures have made drivers available via the Internet. However, the driver that is needed to install a particular card may not be available on the Internet. In such instances, it may be possible to contact the manufacture to obtain the driver. If the driver cannot be obtained, then the device cannot be installed and is useless.

Further, even when the driver has not been compromised, driver installation procedures can be complicated, especially for users who lack experience in such matters. Occasionally, the installation of drivers entails comparatively complicated procedures, such as uninstalling older or otherwise conflicting drivers.

As such, although the prior art has recognized, to a limited extent, the problem of assuring that card drivers are readily available when needed, the proposed solutions have, to date, been ineffective in providing a satisfactory remedy. Therefore, it is desirable to provide a method and system for assuring that card drivers are available when a card is being installed. It is also desirable to simplify and/or automate the card driver installation procedure, such that the requirement for user knowledge and interaction is mitigated.

### BRIEF DESCRIPTION OF THE DRAWINGS

FIG. 1 is a semi-schematic perspective view of a PC Card having non-volatile memory for storing at least one driver and/or a driver installation program, according to an exemplary embodiment of the present invention;

FIG. 2 is a block diagram showing the contents of non-volatile memory of the PC Card of FIG. 1;

FIG. 3 is a flow chart showing a manual method for installing a driver for the PC Card of FIG. 1, according to one exemplary embodiment of the present invention;

FIG. 4 is a flow chart showing an automatic method for installing at least one driver for the PC Card of FIG. 1, wherein a driver installation program is stored in a non-volatile flash memory according to another exemplary embodiment of the present invention; and

FIG. 5 is a flow chart showing another automatic method for installing at least one driver for the PC Card of FIG. 1, wherein a driver installation program is stored in firmware according to yet another exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE PREFERRED EMBODIMENTS

According to one aspect of the present invention, one or more drivers are stored in a non-volatile memory of a computer card. In this manner, the driver(s) are readily available when they are needed for installation. Storing the driver(s) in the non-volatile memory of the card also facilitates automation of the installation procedure, such as via a driver installation program that is also stored in non-volatile memory.

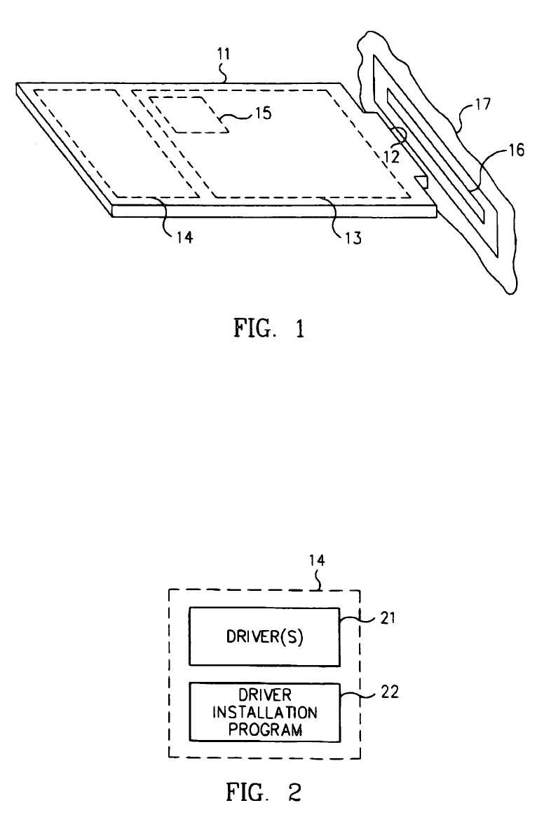

One exemplary embodiment of the present invention, wherein driver installation is performed manually, is illustrated in FIGS. 1-3. Flow charts showing the operation of two alternative embodiments, wherein the driver installation procedure is automated, are provided in FIGS. 4 and 5.

Referring now to FIG. 1, an exemplary embodiment of the present invention comprises a PC Card 11 (also known as a PCMCIA Card), having primary components 13 and a non-volatile memory 14. Primary components 13 perform the intended function of PC Card 11, after the driver(s) for PC Card 11 have been installed. For example, the primary function of PC Card 11 may be providing a network connection (either wired or wireless), mass storage, enhanced input/out capabilities, video capture, global positioning (GPS), security, as well as one or more of a number of other functions.

Non-volatile memory 14 can, for example, comprise a 4 megabyte EEPROM flash memory. Other capacities and/or types of non-volatile memory may alternatively be used. The capacity of the non-volatile memory will depend, at least in part, upon the size of the driver(s) and/or an optionally included driver installation program. Non-volatile memory 14 is used to store one or more drivers that are used to facilitate operation of primary components 13 of PC Card 11, as discussed in detail below. A driver installation program can optionally also be stored in non-volatile memory 14, if desired.

PC Card 11 optionally further comprises firmware, such as that stored by a read only memory (ROM) 15. ROM 15 can be part of the primary components 13 of PC Card 11 or can be separate therefrom. ROM 15 can be used to store the driver installation program, as well as information used by primary components 13. Optionally, ROM 15 can also be used to store the driver(s).

PC Card 11 is slid into a slot 16 of a computer 17 and thus placed in electrical communication with a PCMCIA bus of computer 17 via a connector 12, according to well know principles. However, it is important to appreciate that the discussion of the present invention herein as being embodied in a PC Card is by way of example only, and not by way of limitation. Those skilled in the art will appreciate that the present invention could similarly be embodied in various other types of computer cards, such as Peripheral Component Interconnect (PCI) cards, the VME Extensions for Instrumentation (VXI) cards, Versatile Multibus Extension (VME) cards, and Small Form-Factor ISA (PC-104) cards.

Non-volatile memory 14 and/or ROM 15 can either be permanently attached (such as via soldering) to PC Card 11, or can be removably attached to PC Card 11 (such as via the use of socketed chips). Removable attachment of non-volatile memory 14 and/or ROM 15 to PC Card 11 facilitates updating of the information (such as the driver and/or driver installation program) stored therein by changing the component. Alternatively, the information can be updated by rewriting the information, such as via a computer to which PC Card 11 is attached.

Referring now to FIG. 2, one or more driver(s) 21 and a driver installation program 22 are stored in non-volatile memory 14 of PC Card 11. Alternatively, driver installation program 22 can be stored in firmware, such as read only memory (ROM) 15 of PC Card 11. It is worthwhile to appreciate that memory 14 can comprise more than one memory, more than one type of memory, and/or memory in more than one location.

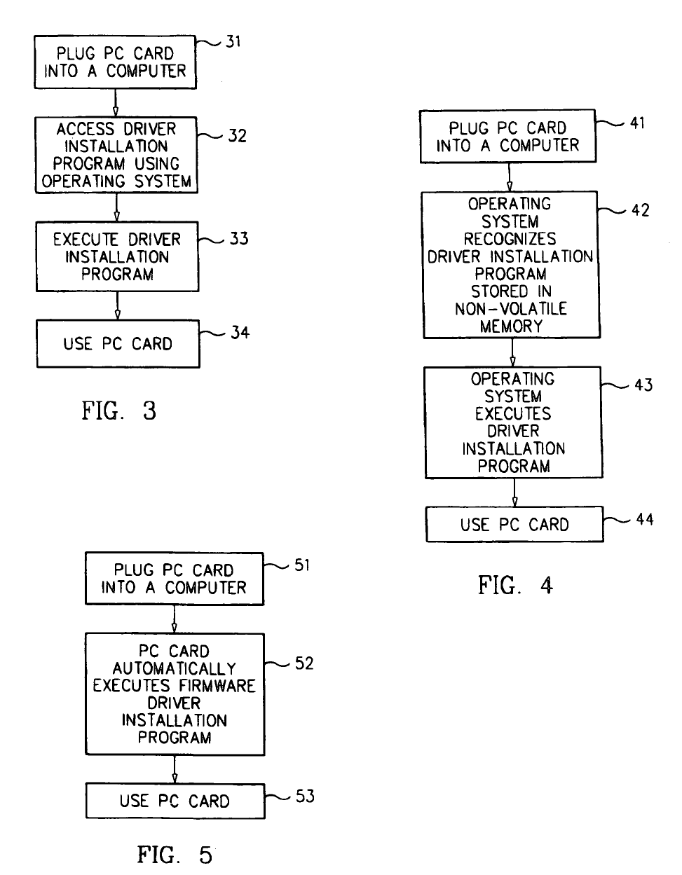

Referring now to FIG. 3, an exemplary manual method for installing PC Card drivers, according to one aspect of the present invention, comprises plugging PC Card 11 into computer 17, as stated in block 31. Typically, PC card 11 is slid into a PC Card slot 16 of a laptop computer or the like, so as to facilitate mechanical and electrical connection thereto.

Contemporary operating systems, such as MICROSOFT® WINDOWS® Millennium, 2000 or XP, do not required additional drivers to access the contents of flash memory. Other operating systems may require the one time installation of a driver to enable the automatic reading of flash memory.

Driver(s) 21 stored in the non-volatile memory 14 are accessed using the operating system of the computer, as stated in block 32. For example, the operating system of computer 17 may assign non-volatile memory 14 a drive letter. The user can then view a directory of the drive, locate driver installation program 22, and execute the driver installation program, as stated in block 33. The driver(s) 21 can also be installed without the use of driver installation program 22. Once the driver has been installed, then PC Card 11 can be used, as desired.

Referring now to FIG. 4, an exemplary automatic method for installing PC Card drivers according to one aspect of the present invention comprises plugging PC Card 11 into computer 17, as stated in block 41. An operating system can be configured to search non-volatile memory 14 when that memory is first attached to computer 17 and to then execute a predetermined program stored in non-volatile memory 14. For example, the operating system can search non-volatile memory 14 of newly attached PC Card 11 and execute a driver installation program 22 having a file name of setup.exe. The operating system knows the name of the file to search for and execute.

According to this exemplary embodiment of the present invention, the operating system recognizes the driver installation program 22 stored in non-volatile memory 14, as stated in block 42. The operating system then executes driver installation program 22, as stated in block 43. Once the driver(s) have been installed, then PC Card 11 can be used, as desired.

The driver and the driver installation program need not be stored in the same non-volatile memory of the card. Indeed, the driver installation program can alternatively be part of the operating system, and thus, at least in some instances, does not need to be stored in a memory of the card.

Referring now to FIG. 5, another exemplary automatic method for installing PC Card drivers, according to one aspect of the present invention, comprises plugging PC Card 11 into computer 17, as stated in block 51. In this instance, driver installation program 22 is stored in firmware, such as on ROM 15. When PC Card 11 is plugged into computer 17, driver installation program 22 can check to see if driver(s) are currently installed in computer 17. If the driver(s) are not currently installed in computer 17, then driver installation program automatically installs driver(s) 22, as stated in block 52. Once driver(s) 22 have been installed, then PC Card 11 can be used, as desired.

Optionally, driver installation program 22 of one or more embodiments of the present invention can be configured to verify that driver(s) 21 are the correct drivers (e.g., are the proper drivers for the computer and/or operating system and are the most current drivers).

By storing the driver(s) in a non-volatile memory of the PC Card, assurance is provided that the driver(s) are available when needed. By storing the driver installation program on the PC Card, such as in the non-volatile memory or in firmware, the installation procedure is substantially simplified.

The non-volatile memory can comprise semiconductor memory, such as flash memory or ROM, or can comprise a disk drive, such as a magnetic disk drive, an optical disk drive, or a magneto-optical disk drive, or can comprise any other type of non-volatile memory.

The present invention is suitable for use in various different types of computing devices, including both desktop computers and portable computing devices such as PDAs, laptops, notebook computers, palmtops, and tablet computers.

The present invention is particularly well suited for use in wireless network PC (PCMCIA) Cards used in portable computing devices. For example, such cards can be provided (sold, rented, loaned, or given away) at Internet hot spots to customers with laptop computers. In this manner, easy and convenient Internet access may be provided.

Computer cards, as the term is used herein, are removably attachable devices, such as peripheral devices, that can be added to a computer to provide desired functionality and can include devices that are placed upon a PCMCIA bus.

Embodiments described above illustrate, but do not limit, the invention. It should also be understood that numerous modifications and variations are possible in accordance with the principles of the present invention. Accordingly, the scope of the invention is defined only by the following claims.

1. A self-installing card for a computer, the card comprising a memory having a driver for the card stored therein.

2. A card for a computer, the card comprising:
a non-volatile memory; and
a driver stored in the non-volatile memory, the driver facilitating operation of the card.

3. The card for a computer as recited in claim 2, wherein the card is selected from a group consisting of a PCMCIA card, a wired network card, and a wireless network card.

4. The card for a computer as recited in claim 2, further comprising a driver installation program stored in the non-volatile memory.

5. The card for a computer as recited in claim 2, further comprising a firmware storage device and a driver installation program stored in the firmware storage device.

6. The card for a computer as recited in claim 2, wherein the non-volatile memory is an EPROM and further comprising a driver installation program stored in the EPROM.

7. The card for a computer as recited in claim 2, further comprising a driver installation program stored in the non-volatile memory, wherein the driver installation program is configured to facilitate auto-execution thereof when the card is plugged into the computer.

8. The card for a computer as recited in claim 2, further comprising a driver installation program stored in the non-volatile memory, wherein the driver installation program cooperates with an operating system of the computer to automatically install the driver.

9. The card for a computer as recited in claim 2, further comprising a driver installation program stored in the memory, wherein the driver installation program cooperates with a Windows Millennium, 2000 or XP operating system to automatically install the driver.

10. The card for a computer as recited in claim 2, wherein the non-volatile memory comprises a memory having a capacity of less than or equal to 16 MB.

11. The card for a computer as recited in claim 2, wherein the non-volatile memory comprises a memory having a capacity of approximately 4 MB.

12. The card for a computer as recited in claim 2, wherein the non-volatile memory is permanently attached to the card.

13. The card for a computer as recited in claim 2, wherein the non-volatile memory is removably attached to the card.

14. The card for a computer as recited in claim 2, further comprising a firmware storage device and a driver installation program stored in the firmware storage device, the driver installation program being configured to search the memory and to automatically install the driver.

15. The card for a computer as recited in claim 2, further comprising a ROM and a driver installation program stored in the ROM.

16. The card for a computer as recited in claim 2, further comprising a firmware storage device and a driver installation program stored in the firmware storage device, wherein the driver installation program is configured to facilitate auto-execution thereof when the card is plugged into the computer.

17. The card for a computer as recited in claim 2, further comprising a firmware storage device and a driver installation program stored in the firmware storage device, wherein the driver installation program cooperates with an operating system of the computer to automatically install the driver.

18. The card for a computer as recited in claim 2, further comprising a firmware storage device and a driver installation program stored in the firmware storage device, wherein the driver installation program cooperates with a Windows Millennium, 2000 or XP operating system to automatically install the driver.

19. A wireless network card comprising:
wireless networking circuitry;
a non-volatile memory;
a wireless network card driver stored in the non-volatile memory, the wireless network card driver being configured to facilitate use of the wireless network card;
a ROM; and
an installation program stored on the ROM, the installation program being configured to automatically install the driver.

20. A portable computing device comprising:
a microprocessor; and
a card in electrical communication with the microprocessor, the card comprising:
a memory; and
a driver stored in the memory.

21. A method for forming a computer card, the method comprising storing a driver on a memory of the card.

22. A method for installing a computer card, the method comprising:
electrically connecting the card to a computer; and installing a driver stored in a memory of the card onto the computer.

23. A card for a computer, the card comprising:
non-volatile means for storing information; and
driver means stored in the non-volatile means for storing information, the driver means facilitating operation of the card.

24. A wireless network card comprising:
means for wireless networking;
non-volatile memory means;
wireless network card driver means stored in the non-volatile memory means, the wireless network card driver means being configured to facilitate use of the wireless network card;
a ROM; and
an installation program stored on the ROM, the installation program being configured to automatically install the wireless network card driver means.

25. A portable computing device comprising:
processing means; and
a card in electrical communication with the processing means, the card comprising:
means for storing information; and
a driver stored in the means for storing information.
